(19) United States
(12) Patent Application Publication
(10) Pub. No.: US 2011/0151362 A1
(43) Pub. Date: Jun. 23, 2011

(54) ELECTROSTATIC IMAGE DEVELOPING GRAY TONER AND IMAGE FORMING METHOD

(75) Inventors: Hiroyuki YASUKAWA, Tokyo (JP); Kaori SOEDA, Tokyo (JP); Miyuki MURAKAMI, Kanagawa (JP)

(73) Assignee: KONICA MINOLTA BUSINESS TECHNOLOGIES, INC., Tokyo (JP)

(21) Appl. No.: 12/960,584

(22) Filed: Dec. 6, 2010

(30) Foreign Application Priority Data
Dec. 18, 2009 (JP) 2009-287444

(51) Int. Cl. G03G 13/01; G03G 9/08

(52) U.S. Cl. 430/42.1; 430/105

(57) ABSTRACT

An electrostatic image developing gray toner is disclosed. The gray toner is composed of toner particles comprising a binding resin, two species of chromatic color coloring agents and carbon black in an amount of 0 to 0.001 weight % of amount of the chromatic color coloring agents, the toner having brightness L* of 30 to 90 and chroma C* of not more than 10 in L*a*b* color system measured in single solid toner image formed by only the gray toner having an amount of toner attached of 4 g/m², and the two species of chromatic color coloring agents satisfying mutually complementary color relation.

This application is based on Japanese Patent Application No. 2009-287444 filed on Dec. 18, 2009, in Japanese Patent Office, the entire content of which is hereby incorporated by reference.

### TECHNICAL FIELD

The present invention relates to an electrostatic image developing gray toner, and an image forming method using the same.

### BACKGROUND TECHNOLOGY

In an image forming method of an electrophotographic system, it has been proposed to improve image gradation and graininess using gray toner (refer, for example, to Patent Documents 1 to 3).

Carbon black is mainly used for a coloring agent of the gray toner because of excellent coloring power. However there is a problem to generate easily image defects such as uneven transfer since carbon black is electroconductive and therefore control of quantity of charge.

Further there is another problem not to obtain gray image with balanced color in case that gray toner contains only one coloring agent.

Carbon black is widely used for a coloring agent of the gray toner because of excellent coloring power, however, there is a problem not to obtain gray image with balanced color in case that carbon black is used as a coloring agent, specifically the obtained image has a hue with a slight reddish tinge.

The reason why such problem is generated is that the toner for forming a black inking image is required to have high developing performance and transfer performance, and in response to the require, a coloring agent is dispersed finely in toner particles of the gray toner for the purpose of improving developing performance and transfer performance. However, carbon black used as a coloring agent has a characteristic that the finer the color materials being dispersed by making them fine particles, the more clearly the color material has a reddish tinge.

On the other hand, in color photographs and other color images, color vividness has been demanded, and thereby, the development of new color materials has been progressing (refer, for example, to Patent Documents 4 and 5). The use of such the newly developed color toners enabled an image in which color chroma and brightness are improved, but in contrast to them, a problem arose that reproduction of a soft tone image having low chroma and a dull tone image having low brightness becomes difficult. It is said that the use of gray toner is effective to dissolve the problems. The soft tone is a bright tone having a little somber tone which gives mild and gentle atmosphere, and the dull tone is a bright tone having a little somber tone which shows mild and complicated expression.

However, there is a problem that, sufficient color reproduction is not obtained due to influence by a reddish tinge developed by black inking by the gray toner when intermediate tone image such as the soft tone image and the dull tone image are formed by employing the gray toner containing carbon black as a coloring agent.

### PRIOR ART DOCUMENT

### Patent Document

Patent Document 1: Japanese Patent Application Publication (hereinafter also referred to as JP-A) 2004-84764
Patent Document 2: JP-A 2004-133247
Patent Document 3: JP-A 2006-227308

Patent Document 4: JP-A 2007-140478
Patent Document 5: JP-A 2007-34264

### SUMMARY OF THE INVENTION

### Problem to be Dissolved by the Invention

The present invention has been achieved based on the above circumstances, and its purpose is to provide an electrostatic image developing gray toner by which a gray image having well balanced tone is obtained as well as the generation of image defects such as uneven transfer is inhibited.

Further, the other purpose is to provide an image forming method in which excellent color reproduction even in a medium tone image can be obtained.

### Technical Means to Dissolve the Problems

An electrostatic image developing gray toner of the invention is composed of toner particles which comprises a binding resin, two species of chromatic color coloring agents and carbon black in an amount of 0 to 0.001 weight % of amount of the chromatic color coloring agents, wherein brightness L* is 30 to 90 and chroma C* is not more than 10 in L*a*b* color system measured in single solid toner image formed by only the gray toner having an amount of toner attached of 4 g/m², and

the two species of chromatic color coloring agents satisfy mutually complementary color relation.

It is preferable that a sum of content of the two species of chromatic color coloring agent is 0.5 to 3 mass parts based on 100 mass parts of the binding resin.

The two species of chromatic color coloring agents may be composed of a yellow coloring agent and a blue coloring agent in the electrostatic image developing gray toner of the invention.

The two species of chromatic color coloring agents may be composed of a magenta coloring agent and a green coloring agent in the electrostatic image developing gray toner of the invention.

The two species of chromatic color coloring agents may be composed of a cyan coloring agent and a red coloring agent in the electrostatic image developing gray toner of the invention.

The image forming method of the invention is that an image forming method using plural numbers of electrostatic image developing toners having different color, characterized in that the electrostatic image developing gray toner is used as the electrostatic image developing toner.

### Advantage of the Invention

A gray image having balanced color without reddish tinge can be formed by an electrostatic image developing gray toner of the invention, since it uses an electroconductive material such as carbon black in minimum amount whereby control of charging amount is easy and consequently generation of image defect such as uneven transfer is inhibited, and two species of chromatic color coloring agents satisfying mutually complementary color relation are contained in toner particles.

An intermediate tone image having good color reproduction can be formed by the image fanning method of the invention since gray color is balanced by using the above described the electrostatic image developing gray toner.

### BRIEF DESCRIPTION OF DRAWING

FIG. 1a is L*a*b* color coordinate showing color space in L*a*b* color system, and FIG. 1b is a*b* color coordinate showing color space in L*a*b* color system.

FIG. 2 is a cross section for explanation showing an example of a constitution of an image forming apparatus which is used for an image forming method using the electrostatic image developing gray toner of the present invention.

### MODE FOR CARRYING OUT THE INVENTION

The present invention will be detailed below.

### Electrostatic Image Developing Gray Toner

The electrostatic image developing gray toner of the invention is composed of toner particles which contain at least a binding resin and two species of chromatic color coloring agents, and contains no or very slight amount of carbon black, and the two species of chromatic color coloring agents satisfy mutually complementary color relation.

The complementary color relation in the invention means that when one is set at the first hue position in Munsell hue circle, the other hue is ranged within ±50° with reference to hue position opposing by diagonal line to the first hue.

The gray toner has brightness L* of 30 to 90 and chroma C* of not more than 10 in L*a*b* color system measured in a single solid toner image formed on an image support by only the gray toner according to the invention having an amount of toner attached of 4 g/m².

It is preferable that the brightness L* is 30 to 50, and chroma C* is 1.5 to 3.0, respectively, in L*a*b* color system measured in single solid toner image formed by only the gray toner having an amount of toner attached of 4 g/m².

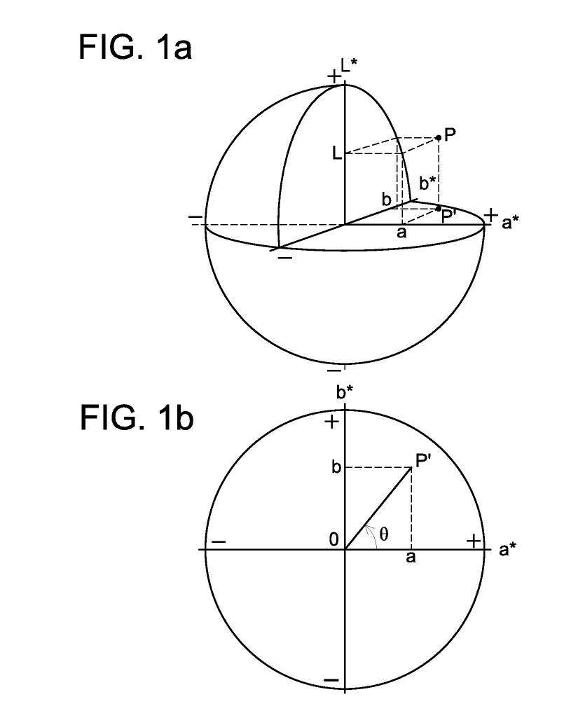

The L*a*b* color system is a useful means which is used to quantify a color. The L* in the z axis direction indicates brightness. The a* in the x axis direction and the b* in the y axis direction indicate a hue of red-green direction and a hue of yellow-blue direction, respectively, shown in FIG. 1. Chroma C* is indicated by a combination of the a* and the b* in the L*a*b* color system, and specifically, the chroma refers to a distance of a certain coordinate point P′ (a, b) from the origin O in an x-y axis plane representing a relationship between the hue and the chroma when, for example, a certain color takes the coordinate point P, and is calculated by the following Formula (C*). The brightness indicates the relative brightness of color, the hue indicates a tone of color such as red, yellow, green, blue and purple, and the chroma indicates a degree of vividness of color.

Chroma (C*)=[(a*)²+(b*)²]^{1/2}, Formula (C):

wherein a* and b* of above Formula (C) represent values of a and b at a coordinate point (a, b) respectively.

Specifically, the L*a*b* for calculation of the hue angle is determined using the GRETAG MACBETH SPECTROLINO (manufactured by Gretag Macbeth) with conditions that D65 is used as a light source, an aperture of 4 mm in diameter for reflection measurement is used, at an interval of 10 nm in the range of 380 to 730 nm of the measuring wavelength, the viewing angle is set to 2 degrees, and an exclusive white tile is used for a reference.

Total amount of two species of chromatic color coloring agents in the gray toner of the invention is preferably 0.5 to 3 mass parts and more preferably 1.0 to 2.5 mass parts with reference to 100 mass parts of binding resin.

Gray image balanced in color is obtained by taking the total amount of two species of chromatic color coloring agents within the above described range. Sufficient coloring power may not obtained, when the total amount of two species of chromatic color coloring agents is not less than 0.5 mass parts, and brightness difference between the black image and gray image becomes small and the formed image may not have good granularity at high light portion when the total amount of two species of chromatic color coloring agents excess 3 mass parts.

A combination of two species of chromatic color coloring agents in mutually complementary color relation used in the gray toner of the invention includes a combination of yellow coloring agent with blue coloring agent, a combination of magenta coloring agent with green coloring agent, and a combination of cyan coloring agent with red coloring agent.

### Yellow Coloring Agent

Yellow coloring agents include, for example, a nitro type pigment such as Naphthol Yellow S(C.I.10316); an azo type pigment such as Hansa Yellow (C.I.11680), Hansa Yellow 3G (C.I.11670), Hansa Yellow 50 (C.I.11660), Hansa Yellow 10G (C.I.11710), Hansa Yellow GR (C.I.11730), Hansa Yellow A (C.I.11735), Hansa Yellow RN (C.I.117408), Hansa Yellow R (C.I.12710), Pigmentt Yellow L (C.I.12720), Benzidine Yellow G (C.I.21090), Benzidine Yellow AAOT (C.I.21095), Benzidine Yellow GR (C.I.21100), Permanent Yellow NCG (C.I.20040), Vulcan Fast Yellow 5G (C.I.21220), Vulcan Fast Yellow R(C.I.21135), Tartrazine Lake (C.I.19140), Permanent Yellow FGL, Permanent Yellow H10G, Permanent Yellow HR, and Chromophthal Yellow; an acid dye type lake pigment such as Quinoline Yellow Lake (C.I.47005); a vat color dyeing type pigment Anthragen Yellow 6GL (C.I.60520), and Anthrapyrimidine Yellow; an isoindolinone type pigment such as Isoindolinone Pigment; a mono-azo type pigment; a dis-azo type pigment; an isoindoline type pigment such as C.I. Pigment Yellow 139; and a benzimidazolone type pigment.

### Blue Coloring Agent

Blue coloring agent include, for example, an acid dye type lake pigment such as Metal free phthalocyanine blue (C.I.74100), Alkali Blue Lake (C.I.42750A, C.I.42770A), and Peacock Blue Lake (C.I.42090); a basic dye type lake pigment such as Rhodamine Blue 6G (C.I.42025), Victoria Blue Lake (C.I.44045); and a vat color dyeing type pigment such as Indanthrene Blue RS (C.I.69800), Indanthrene Blue BC (C.I.69825), Indigo, C.I. Pigment Blue 60.

### Magenta Coloring Agent

Magenta coloring agents include, for example, a thioxanthene type compound, a condensed azo compound, a diketopyrrolopyrrole compound, an anthraquinone compound, a quinacridone compound, a base dye lake compound, a naphthol compound, a benzimidazolone compound, a thioindigo compound, and a perylene compound, and specifically, C.I. Pigment Red 2, Pigment Red 3, Pigment Red 5, Pigment Red 6, Pigment Red 7, Pigment Red 23, Pigment Red 48:2, Pigment Red 48:3, Pigment Red 48:4, Pigment Red 57:1, Pigment Red 81:1, Pigment Red 144, Pigment Red 146, Pigment Red 166, Pigment Red 169, Pigment Red 177, Pigment Red 184, Pigment Red 185, Pigment Red 202, Pigment Red 206, Pigment Red 220, Pigment Red 221, Pigment Red 254, and C.I. Solvent Orange 63.

### Green Coloring Agent

Green coloring agents include, for example, a copper halide phthalocyanine type pigment such as C.I. Pigment green 7; and an anthraquinone type pigment.

### Cyan Coloring Agent

Cyan coloring agents include, for example, a phthalocyanine type pigment such as Phthalocyanine Blue (C.I.74100), Fast Sky Blue (C.I.74180), and C.I. Pigment Blue 16.

### Red Coloring Agent

Red coloring agents include, for example, a quinacridone type pigment such as C.I. Pigment Red 122, C.I. Pigment Red 202, C.I. Pigment Red 207, C.I. Pigment Red 209, C.I. Pigment Violet 19; a perinone type pigment such as C.I. Pigment Red 123, C.I. Pigment Red 149, C.I. Pigment Red 179, C.I. Pigment Red 189, C.I. Pigment Red 190; an anthraquinone type pigment such as C.I. Pigment Red 194; C.I. Pigment Red 168, Pigment Red 177, Pigment Red 216; thioindigo type pigment such as C.I. Pigment Red 86, C.I. Pigment Red 88, and C.I. Pigment Red 198; and a diketopyrrolopyrrole type pigment such as C.I. Pigment Red 254.

When the combination of the two species of chromatic color coloring agent is composed of a yellow coloring agent and a blue coloring agent, preferable practical includes C.I. Pigment Yellow 139 (an isoindolinone type pigment) as a yellow coloring agent and, C.I. Pigment blue 60 (a vat color dyeing type pigment) as a blue coloring agent. When the combination of the two species of chromatic color coloring agent is composed of a magenta coloring agent and green coloring agent, preferable practical example includes C.I. Solvent Orange 63 (a thioxanthene type compound) as a magenta coloring agent and C.I. Pigment green 7 (a copper halide phthalocyanine type pigment) as a green coloring agent. Further, when the combination of the two species of chromatic color coloring agent is composed of a cyan coloring agent and a red coloring agent, preferable practical example includes C.I. Pigment blue 16 (a phthalocyanine type pigment) as a cyan coloring agent and C.I. Pigment Red 179 (a perylene type pigment) as a red coloring agent.

The binding resin incorporated in the gray toner particles constituting the gray toner of the present invention includes, is not particularly limited and conventional resin can be used.

In case where the gray toner particles are produced by a method such as a pulverization method and a dissolution suspension method, vinyl series resin such as styrene series resin, (meth)acryl series resin, styrene-(meth)acryl series copolymer resin, and olefin series resin, polyester series resin, polyamide series resin, polycarbonate series resin, polyether series resin, polyvinyl acetate series resin, polysulfone resin, epoxy resin, polyurethane resin, and urea resin.

In the method for producing the gray toner, the binding resin composing the gray toner particles, which are formed in case of using the emulsion polymerization and coagulation method, includes various conventional polymerizable monomers. Examples of the polymerizable monomers include vinyl type monomers and it is preferable to use in combination with those having ionic dissociation group. A binding resin having cross linked structure can be obtained by employing a multi-functional vinyl type monomer.

The gray toner particles constituting the gray toner of the present invention may, if desired, further incorporate a charge control agent, magnetic powder, a releasing agent, and the like.

### (Magnetic Powder)

In case where the gray toner particles are constituted with magnetic powder being incorporated, as the magnetic powder, usable is, for example, magnetite, γ-hematite, or various kinds of ferrite.

The content ratio of the magnetic powder is preferably 10 to 500 parts by mass, and more preferably 20 to 200 parts by mass, with respect to 100 parts by mass of the binding resin constituting the gray toner particles.

### (Charge Control Agent)

In case where the gray toner particles are constituted with a charge control agent being incorporated, as the charge control agent, various substances can be used as long as the substance can provide a positive or negative charge via triboelectric charging. Specifically, the positive charge control agent includes, for example, nigrosine series dye such as NIGROSINE BASE EX (produced by Orient Chemical Industries Ltd.); tert-ammonium salt such as Tert-Ammonium Salt P-51 (produced by Orient Chemical Industries Ltd.), COPY CHARGE PX VP435 (produced by Hoechst Japan), and imidazole compound such as alkoxylated amine, alkylamide, molybdic acid chelate pigment, and PLZ-1001 (produced by Shikoku Chemicals Corp.). The negative charge control agent includes, for example, metal complex such as BONTRON S-22 (produced by Orient Chemical Industries Ltd.), BONTRON S-34 (produced by Orient Chemical Industries Ltd.), BONTRON E-81 (produced by Orient Chemical Industries Ltd.), BONTRON E-84 (produced by Orient Chemical Industries Ltd.), and SPILON BLACK TRH (produced by Hodogaya Chemical Co., Ltd.); thioindigo series pigment; tert-ammonium salt such as COPY CHARGE NX VP434 (produced by Hoechst Japan); calixarene compound such as BONTRON E-89 (produced by Orient Chemical Industries Ltd.); boron compound such as LR-147 (produced by Japan Carlit Co., Ltd.); and fluorine compound such as magnesium fluoride, and carbon fluoride. As the metal complex used as the negative charge control agent, usable are metal complexes having various structures, such as oxycarboxylic acid metal complex, dicarboxylic acid metal complex, amino acid metal complex, diketone metal complex, diamine metal complex, azo group containing benzene-benzene derivative frame metal complex, and azo group containing benzene-naphthalene derivative frame metal complex.

As described above, by the gray toner particles being constituted with a charge control agent being incorporated, the charging characteristic of the gray toner can be improved.

The content ratio of the charge control agent is preferably 0.01 to 30 parts by mass, and more preferably 0.1 to 10 parts by mass, with respect to 100 parts by mass of the binding resin.

### (Releasing Agent)

In case where the gray toner particles are constituted with a releasing agent being incorporated, as the releasing agent, various waxes can be used. As the wax, preferably usable are polyolefin type waxes such as low molecular polypropylene and polyethylene, and oxidized polypropylene and polyethylene.

The content ratio of the releasing agent is preferably 0.1 to 30 parts by mass, and more preferably 1 to 10 parts by mass, with respect to 100 parts by mass of the binding resin.

The gray toner particles constituting the gray toner of the present invention may have a core-shell structure, which is composed of a core particle incorporating a binding resin and a coloring agent, and a shell layer composed of shell layer forming resin, which layer covers the outer circumferential surface of the above core particle. With the gray toner particles being constituted of the core-shell structure, the aforesaid gray toner particles can have a high production stability and storage stability.

The gray toner particle having the above core-shell structure may be not only a form in which the shell layer completely covers the core particle, but also a form in which the shell layer covers a part of the core particle. There may also be a form that a part of the shell resin constituting the shell layer forms a domain and the like in the core particle. Further, there may also be a form that the shell layer has a multilayer structure of two or more layers composed of resins having a different composition.

### (Production Method of Gray Toner)

The gray toner of the invention can be produced by obtaining gray toner particles employing a binding resin or a polymerizable monomer to obtain the binding resin, two species of chromatic color coloring agents, and inner additives if necessary, and adding an external additives if necessary. To the toner particles.

The method for producing the gray toner of the present invention includes a kneading and pulverization method, a suspension polymerization method, an emulsion polymerization method, an emulsion polymerization and coagulation method, a mini emulsion polymerization and coagulation method, and an encapsulation method. Of these, the emulsion polymerization and coagulation method is preferably used, in consideration that it is necessary to obtain gray toner composed of small-sized particles to achieve a high quality image. The emulsion polymerization and coagulation method is a method to produce the gray toner particles in such a way that a dispersion of particulates composed of binding resin produced by a emulsion polymerization method (hereinafter also referred to “binding resin particulates”) is mixed with a dispersion of particulates composed of coloring agents (hereinafter also referred to “coloring agent particulates”), which mixture is then slowly coagulated while taking a balance of the surface repulsive force of particulates by pH adjustment and the coagulation force by addition of coagulant composed of electrolytes, and then, fusion bonding between the particulates is carried out by carrying out association between them while controlling the average particle size and the particle distribution, and, at the same time, heating and stirring is carried out for controlling the shape.

Binding resin particles obtained by an emulsion polymerization method may have multi-layer construction of two or more layers composed of different components, in case that the gray toner is produced by an emulsion polymerization coagulation method. The binding resin particles having such construction can be formed, for example those having two layer construction, by a method in which dispersion of resin particles are prepared in accordance with usual emulsion polymerization (first step polymerization) and a polymerization initiator and a polymerizable monomer are added to the dispersion to conduct polymerization (second step polymerization).

Toner particles having core shell structure can be obtained by the emulsion polymerization coagulation method. Practically, the toner particles having core shell structure can be obtained by forming core particles by coagulating, associating and fusing the binding resin microparticles for core particles and microparticles of two chromatic color coloring agents at first, then forming shell layer by adding binding resin microparticles for forming shell layer into dispersion of core particles and coagulating and fusing the binding resin microparticles on the surface of the core particles. Thus shell layer covering core surface is formed.

### (Size of Gray Toner Particle)

The size of the gray toner particle constituting the above gray toner has preferably, for example, a volume-based median size of 4 to 10 μm, and more preferably 5 to 9 μm.

The volume-based median size being in the above range increases a transfer efficiency to improve the quality of halftone-image, and improves quality of narrow lines, and dot images.

The volume-based median size of the gray toner particle is measured and calculated via a measuring apparatus in which the COULTER MULTISIZER TA-III (manufactured by Beckman Coulter Inc.) is connected with a computer system for data processing (manufactured by Beckman Coulter Inc.). Specifically, the above measurement is carried out as follows: 0.02 g of gray toner is soaked in 20 ml of surface active agent solution (being a surface active agent solution, employed for the purpose of dispersion of the gray toner, which solution is prepared, for example, by diluting a neutral detergent containing a component of surface active agent by a factor of 10 in pure water) and the resulting mixture is subjected to an ultrasonic dispersion for one minute to prepare a gray toner dispersion. Then the gray toner dispersion is charged using a pipette into a beaker containing ISOTON II (produced by Beckman Coulter Inc.), placed on a sample stand, to achieve a measured concentration of 5% to 10%. By making the concentration to be within the above range, reproducible measured values can be obtained. In the measuring apparatus, the count of the measuring particles is set to 25,000, and the aperture size is set to 50 μm, a frequency value is calculated with a range of from 1 to 30 μm, in which the determination was performed, being divided into 256 portions, and then, a particle size at 50% from a large size of a cumulative volume fraction was used as the volume-based median size.

### (Average Circular Degree of Gray Toner Particle)

The gray toner of the present invention preferably has, on each of the gray toner particles constituting the gray toner, from a viewpoint of improvement of the transfer efficiency, the average circular degree, represented by Formula (T) below, of 0.930 to 1.000, and more preferably 0.950 to 0.995.

Circular degree=(Circumference of a circle determined from a diameter equivalent to a circle)/(Circumference of a projected particle image) Formula (T):

### (External Additive)

The above gray toner particles can be used as the gray toner having the constitution composed of the binder resin and coloring agent, but may have a constitution in which, to improve fluidity, a charging characteristic, cleaning property, and the like, an external additive such as a fluidity agent and a cleaning aid, which are a so-called post-treatment agent, is added to the aforesaid gray toner particles.

The post-treatment agent includes, for example, inorganic oxide particulates such as silica particulates, alumina particulates, and titanium oxide particulates; inorganic stearic acid compound particulates such as aluminum stearate particulates, and zinc stearate particulates; and inorganic titanic acid compound particulates such as strontium titanate, and zinc titanate.

It is preferable that these particulates are subjected to surface treatment by a silane coupling agent, titanium coupling agent, higher fatty acid or silicone oil to improve heat-resistant storage property and environmental stability.

The total amount of these various external additives to be added is 0.05 to 5 parts by mass, and preferably 0.1 to 3 parts by mass, with respect to 100 parts by mass of the gray toner. The external additives may be used as a combination of the various kinds thereof.

### (Developer)

The gray toner of the present invention may be used as a magnetic or non-magnetic single component developer, but may be used as a two-component developer mixed with a carrier.

In case where the gray toner of the present invention is used as the two-component developer, usable as the carrier are magnetic particles composed of materials such as metals such as iron, ferrite and magnetite, and alloys of the foregoing metals and a metal such as aluminum, of which ferrite particles are particularly preferred. As the carrier, there may also be used a coated carrier in which the surface of the magnetic particle is covered with a covering agent such as resin, or a binder type carrier in which magnetic fine powder is dispersed in binder resin.

The covering resin constituting the coated carrier includes, for example, olefin series resin, styrene series resin, styrene-acryl series resin, silicone resin, ester resin, and fluorine resin. As the resin constituting the resin dispersion type carrier, fore example, styrene-acryl series resin, polyester resin, fluorine resin, and phenol resin can be used.

A volume-based median size of the carrier is preferably 20 to 100 μm, and more preferably 20 to 60 μm. The volume-based median size of the carrier is typically determined by a laser diffraction particle size distribution analyzer provided with a wet disperser (HELOS, manufactured by Sympatec Co., Ltd.).

According to the gray toner, which uses no or very slight amount of an electroconductive material such as carbon black, charge control is easy, and subsequently occurrence of image defects such as uneven transfer is inhibited, and further, a gray image having balanced color without a reddish tinge can be formed because it contains two species of chromatic color coloring agents satisfy mutually complementary color relation in the toner particles.

### (Method for Forming Image)

The image forming method of the present invention is featured by using the gray toner, and a method for forming a visible image by using the gray toner as well as toners of different colors.

The image forming method of the present invention includes practically the following methods (1) and (2).

(1) A method in which a visible image is formed in the following manner: a toner image forming process, in which a toner image, formed in a manner that an electrostatic latent image formed on an electrostatic latent image bearing body is visualized with toner, is directly transferred onto an image support, is carried out by repeating two or more times, using toners of different colors, in which one of the above processes is carries out using the above-described gray toner of the present invention, whereby a color toner image is formed on the image support to obtain an image support bearing the color toner image, which color toner image is then fixed to the image support.

(2) A so-called intermediate transfer method, in which a visible image is formed in the following manner: a process, in which a toner image, formed in a manner that an electrostatic latent image formed on an electrostatic latent image bearing body is visualized with toner, is transferred onto an intermediate transfer body, is carried out by repeating two or more times, using toners of different colors, in which one of the above processes is carries out using the above-described gray toner of the present invention, and after the color toner image is formed on the intermediate transfer body, the image is transferred onto a image support such as a paper, which is then fixed.

The toner for forming the color toner image includes black toner, yellow toner, magenta toner, and cyan toner, other than the gray toner.

The color toners are not particularly limited and conventional one containing binding resin and a coloring agent can be used.

The black toner preferably has brightness L* of not more than 30 and chroma C* of not more than 5 in single solid toner image formed by the gray toner according to the invention having an amount of toner attached of 4 g/m².

A content of coloring agent is preferably 3 parts by mass or more with respect to 100 parts by mass of a binding resin in the black toner.

The yellow toner is composed of yellow toner particles, having a hue angle H in a range of 45 to 100 degrees, in single solid toner image formed by the yellow toner having an amount of toner attached of 4 g/m².

A content of coloring agent is preferably 1 to 10 parts by mass or more with respect to 100 parts by mass of a binding resin in the yellow toner.

The hue angle H refers to an angle θ between a line formed a certain coordinate point P′(a, b) and the origin O and a line extending to a plus direction of an x axis a*, and is calculated by the following Formula (H).

Hue angle=tan⁻¹(b*/a*), Formula (H):

wherein a* and b* of above Formula (H) represent values of a and b at a coordinate point (a, b) respectively.

The cyan toner is composed of yellow toner particles, having a hue angle H in a range of 200 to 280 degrees, in single solid toner image formed by the yellow toner having an amount of toner attached of 4 g/m².

A content of coloring agent is preferably 1 to 10 parts by mass or more with respect to 100 parts by mass of a binding resin in the cyan toner.

The magenta toner is composed of yellow toner particles, having a hue angle H in a range of 300 to 360 degrees and 0 to 15 degrees, in single solid toner image formed by the magenta toner having an amount of toner attached of 4 g/m².

A content of coloring agent is preferably 1 to 10 parts by mass or more with respect to 100 parts by mass of a binding resin in the magenta toner.

The image forming method using five colors of a black, gray, yellow, magenta and cyan toner can be practiced by an image forming apparatus, for example, described below.

### (Image Forming Apparatus)

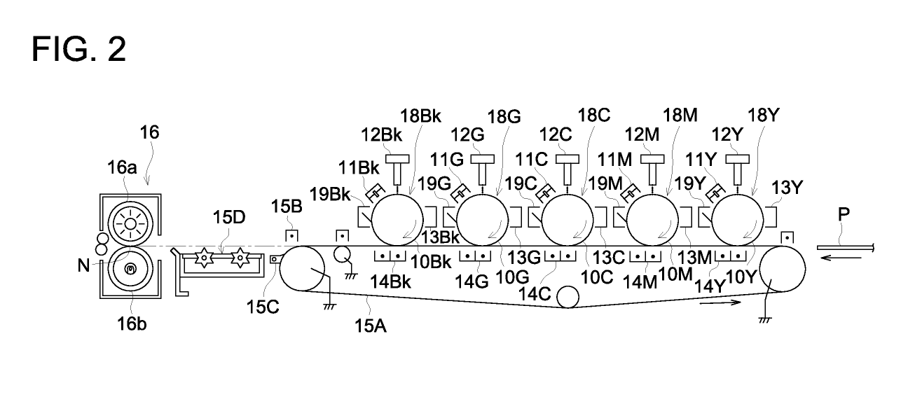

FIG. 2 is a cross section for explanation showing an example of a constitution of an image forming apparatus which is used for an image forming method using the gray toner of the present invention.

The image forming apparatus is a so-called direct transfer system full color image forming apparatus having a constitution in which five image forming units 18Y, 18M, 18C, 18G, 18Bk are arranged along a conveyance belt 15A, and having no intermediate image transfer body.

Each of the image forming units 18Y, 18M, 18C, 18G, and 18Bk is configured such that a photoconductor layer composed of a conductive layer and an organic photoconductor (an OPC) is formed on the periphery of a cylindrical substrate, and is provided with each of photoconductive drums 10Y, 10M, 10C, 10G, and 10Bk, which is a electrostatic latent image bearing body, and is rotated in the clockwise direction, with the conductive layer being grounded, by power from a driving source (not illustrated), or by being moved with the conveyance belt 15; each of chargers 11Y, 11M, 11C, 11G, and 11Bk comprising, for example, a scorotron charger, which provides uniform potential on each of the surfaces of the aforesaid photoconductive drums 10Y, 10M, 10C, 10G, and 10Bk by corona discharge having the same polarity as the toner, and which is arranged in the perpendicular direction to the moving direction of the photoconductive drums 10Y, 10M, 10C, 10G, and 10Bk; each of exposing devices 12Y, 12M, 12C, 12G, and 12Bk comprising, for example, a polygon mirror, which carries out a scanning parallel to a rotating axis of each of the photoconductive drums 10Y, 10M, 10C, 10G, and 10Bk, and forms a latent image by carrying out an image exposure based on image data on each of the surfaces of uniformly charged photoconductive drums 10Y, 10M, 10C, 10G, and 10Bk; and each of developing devices 13Y, 13M, 13C, 13G, and 13Bk, which is provided with a rotating developing sleeves (not illustrated), and conveys toner held on the sleeve to each of the surfaces of the photoconductive drums 10Y, 10M, 10C, 10G, and 10Bk.

In FIG. 2, 19Y, 19M, 19C, 19G, and 10Bk are cleaning devices.

The yellow, magenta, cyan, light gray, and black toner images are formed by the image forming units 18Y, 18M, 18C, 18G, and 18Bk, respectively.

As the conveyance belt 15A which conveys an image support P, usable is a belt, which is provided with conductivity by adding conductive filler, such as carbon black, to polymer film such as film composed of polyimide, polycarbonate, and PVdF, or to synthetic rubber such as silicone rubber, and fluorine rubber. The belt may be a drum shape or a belt shape, but is preferably a belt shape from the viewpoint of expanding the possibility of apparatus design.

It is preferable that the surface of the conveyance belt 15A is made rough to some degree, and for example, the ten-point mean surface roughness Rz is made 0.5 to 2 μm. The rough surface of the conveyance belt 15A as described above ensures close contact between the image support P and the conveyance belt 15A, and prevents fluctuation of the image support P on the conveyance belt 15A, whereby transfer properties of toner images, from the photoconductive drums 10Y, 10M, 10C, 10G, and 10Bk to the image support P, can be favorably achieved.

In such an image forging apparatus, a color toner image is initially formed on the image support P in the following manner: toner images composed of each of the colors formed on each of the photoconductive drums 10Y, 10M, 10C, 10G, and 10Bk of each of the image forming units 18Y, 18M, 18C, 18G, 18Bk are successively transferred and superposed on each other onto the image support P, which is conveyed by the conveyance belt 15A at just a right moment.

The image support P, on which the above color toner image is borne, is separated from the conveyance belt 15A by both discharging action of an AC discharger arranged downstream of the transfer region of the image forming unit 18Bk of the conveyance belt 15A, and separation action of a separation tab 15C arranged at a position with a prescribed spacing from a conveyance section 15D which separated image support P is then conveyed to the conveyance section 15D, and then, conveyed to a fixing device 16 through the aforesaid conveyance section 15D.

Then, at the fixing device 16, the color toner images superposed on the image support P are fixed by application heat and pressure to the image support P being nipped at a nip portion N formed by a heat roll 16a and pressure roll 16b, after which the image support P carrying the fixed image is ejected outside the apparatus.

In the image forming method of the present invention, in case where a monochrome image is formed using, for example, a black toner and a gray toner, a toner image made of the gray toner is preferably formed on an image support superposing on the previously formed black toner.

Specifically, in an image forming method by an image forming apparatus of an intermediate transfer system, it is preferable that a developing process of the black toner is carried out in advance, and subsequently a gray toner developing process of the toner is carried out. On the other hand, in an image forming method by an image forming apparatus of a direct transfer system as shown in FIG. 2, it is preferable that a developing process of the gray toner is carried out in advance, and subsequently a developing process of the black toner is carried out.

In case where a color image is formed using, for example, a gray toner together with a yellow toner, a magenta toner and a cyan toner, a toner image made of the gray toner is preferably formed on an image support superposing on toner images having other colors than gray color.

Specifically, in an image forming method by an image forming apparatus of an intermediate transfer system, it is preferable that developing processes of each of toners are carried out in a sequence of a gray toner, a yellow toner, a cyan toner and a magenta toner. On the other hand, in an image forming method by an image forming apparatus of a direct transfer system as shown in FIG. 2, it is preferable that developing processes of each of toners are carried out in a sequence of a yellow toner, a magenta toner, a cyan toner, a gray toner and a black toner.

In case where a color image is formed, due to developing processes in the above sequence, since the degree of image somberness due to color toners placed in the lower layers can be regulated by an amount of gray toner attached and an area ratio of superimposed dots, a visible image of increased expressiveness and a high quality can be formed even in case where a dark grayish tone image and a dull tone image are formed.

A halftone image having good color reproduction can be formed by the image forming method because color with reference is balanced by using the gray toner of the invention.

### (Image Support)

The image support employed in the image forming method using the above gray toner includes a various kinds of supports such as a regular paper including a thin paper and a thick paper, a high-quality paper, a coated printing paper such as an art paper and a coated paper, a commercially available Japanese paper or post card, a plastic film used for OHP, and a cloth.

The gray toner of the present invention and the embodiment of an image forming method using the same were described above, but various modifications can be added to them.

### EXAMPLES

Specific examples of the present invention will be described below.

### Production Example 1 of Gray Toner

### (1) Preparation of Resin Particle A

### (1-1) First Step Polymerization

Into a 5 liter reaction vessel equipped with a stirrer, a temperature sensor, a cooling tube and a nitrogen gas introducing apparatus, added was a solution, which was prepared by dissolving 8 g of sodium dodecyl sulfate into 3 litters of ionized water, and then, the temperature of the resultant solution was raised to 80° C. while stirring at 230 rpm under nitrogen gas flow. After that, a solution, which was prepared by dissolving 10 g of potassium persulfate into 200 g of ionized water, was added, and then, the temperature of the resultant solution was raised again to 80° C. Subsequently, a monomer mixed solution composed of the following materials was dropped over one hour:

| | | |
|---|---|---|
| styrene | 480 | g |
| n-butylacrylate | 250 | g |
| methacrylic acid | 68 | g |
| n-octyl-3-mercaptopropionate | 16 | g |

The resulting solution was polymerized by stirring and heating at 80° C. for two hours, to prepare resin particles (1H):

### (1-2) Second Step Polymerization

Into a 5 liter reaction vessel equipped with a stirrer, a temperature sensor, a cooling tube and a nitrogen gas introducing apparatus, added was a solution, which was prepared by dissolving 7 g of sodium polyoxyethylene (2) dodecylether sulfate into 800 ml of ionized water, which was then, heated to 98° C. After that, to the above vessel added was a solution, which was prepared by dissolving 260 g of above resin particles (1H) and a monomer mixed solution composed of the following materials:

| | |
|---|---|
| styrene | 245 g |
| n-butylacrylate | 120 g |
| n-octyl-3-mercaptopropionate | 1.5 g |
| paraffin wax (melting point: 45° C.) | 190 g |

The resulting solution was mixed and dispersed over one hour via “CLEARMIX” (manufactured by M-Technique Co., Ltd.), being a mechanical dispersion apparatus equipped with a circulation pathway, to prepare a dispersion liquid containing emulsified particles (oil droplets).

Subsequently, a polymerization initiator solution, which was prepared by dissolving 6 g of potassium persulfate into 200 ml of ionized water, was added to the above dispersion liquid, which solution was then polymerized by stirring and heating at 82° C. over one hour, to prepare resin particles (1HM).

### (1-3) Third Step Polymerization

Furthermore, a solution, which was prepared by dissolving 11 g of potassium persulfate into 400 ml of ionized water, was added to resin particles (1 HM), and then, a monomer mixed solution composed of the following materials was dropped over one hour at 82° C.:

| | | |
|---|---|---|
| styrene | 435 | g |
| n-butylacrylate | 130 | g |
| methacrylic acid | 33 | g |
| n-octyl-3-mercaptopropionate | 8 | g |

After completion of the dropping, the resultant mixed solution was polymerized by heating and stirring over two hours, after which the solution was cooled down to 28° C., to prepare a dispersion of resin particles (A).

### (2) Preparation of Resin Particle B

Into a 5 liter reaction vessel equipped with a stirrer, a temperature sensor, a cooling tube and a nitrogen gas introducing apparatus, added was a solution, which was prepared by dissolving 23 g of sodium dodecyl sulfate into 3 litters of ionized water, and then, the temperature of the resultant solution was raised to 80° C. while stirring at 230 rpm under nitrogen gas flow. After that, a solution, which was prepared by dissolving 10 g of potassium persulfate into 200 g of ionized water, was added, and then, the temperature of the resultant solution was raised again to 80° C. Subsequently, a monomer mixed solution composed of the following materials was dropped over one hour:

| | | |
|---|---|---|
| styrene | 520 | g |
| n-butylacrylate | 210 | g |
| methacrylic acid | 68 | g |
| n-octyl-3-mercaptopropionate | 16 | g |

The resulting solution was polymerized by stirring and heating at 80° C. for two hours, to prepare a dispersion of resin particles (B)

### (3) Preparation of Coloring Agent Dispersion

### Preparation Example 1 of Coloring Agent Dispersion

Ninety grams of sodium dodecyl sulfate was dissolved by stirring into 1,400 g of ionized water. While stirring the resultant solution, 1073 g of a yellow coloring agent C.I. Pigment Yellow 139 as the first coloring agent and 103.7 g of a blue coloring agent, C.I. Pigment Blue 60 as a second coloring agent were gradually added into the solution. Subsequently, the above solution was subjected to a dispersion treatment using a stirring means “CLEARMIX” (manufactured by M-Technique Co., Ltd.), to prepare a dispersion of coloring agent particles, which is hereinafter, referred to as “coloring agent dispersion (1)”.

### Preparation Examples 2 to 9 of Coloring Agent Dispersion

Coloring agent dispersions (2) to (9) were prepared in a similar manner to preparation example 1 of the coloring agent dispersion except that species and amount of coloring agents described in Table 1 were used.

TABLE 1

| Coloring | First Coloring Agent | | Second Coloring Agent | |
|---|---|---|---|---|
| agent | | Amount | | Amount |
| dispersion No. | Name | (parts by mass) | Name | (parts by mass) |
| 1 | C.I. Pigment Yellow 139 | 3.0 | C.I. Pigment Blue 60 | 2.9 |
| 2 | C.I. Solvent Orange 63 | 2.6 | C.I. Pigment Green 7 | 2.7 |
| 3 | C.I. Pigment Blue 16 | 2.4 | C.I. Pigment Red 179 | 2.5 |
| 4 | C.I. Pigment Yellow 83 | 2.3 | C.I. Pigment Blue 60 | 2.2 |
| 5 | C.I. Pigment Orange 43 | 3.1 | C.I. Pigment Green 2 | 3.8 |
| 6 | C.I. Pigment Blue 15:3 | 2.6 | C.I. Pigment Red 149 | 2.7 |
| 7 | Carbon Black #10 | 17.4 | — | — |
| 8 | Carbon Black #10 | 1.1 | — | — |
| 9 | C.I. Pigment Blue 15:3 | 6.4 | C.I. Pigment Red 149 | 6.8 |

### (4) Production of Gray Toner Particles

Into a 5 liter reaction vessel equipped with a stirrer, a temperature sensor, a cooling tube and a nitrogen gas introducing apparatus, added were 336.7 g (equivalent converted to solids) of resin particles (A), 1,400 g of ionized water, 82 g of above-described coloring agent dispersion (1), and a solution, which was prepared by dissolving 3 g of sodium polyoxyethylene (2) dodecylether sulfate into 1,200 ml of ionized water, and then the temperature of the mixture solution was adjusted to 30° C., after which the pH of the solution was adjusted to 10 by adding a 5N aqueous solution of sodium hydroxide. Subsequently, an aqueous solution, which was prepared by dissolving 35 g of magnesium chloride in 35 ml of ionized water, was added in the above solution, while stirring over 10 minutes at 30° C. After standing the solution for 3 minutes, the temperature rising was started and the temperature of the above system was raised to 90° C. over 60 minutes, and then a particle growth reaction was continued while keeping the temperature at 90° C. During the particle growth reaction, the particle size of the coagulated particles was determined using the “COULTER MULTISIZER TA-III” (manufactured by Beckman Coulter Inc.). At a time when the volume based median size reached 3.1 μm, 265.2 g (equivalent converted to solids) of resin particles (B) was added, and the particle growth reaction was further continued. At a time when the particle size reached to 6.5 μm, an aqueous solution, in which 150 g of sodium chloride was dissolved in 600 ml of ionized water, was added to stop the particle size growth. Furthermore, by heating and stirring at the solution temperature of 98° C. as the fusion-bonding process, the fusion-bonding among particles was continued until the circularity became 0.965 measured by FPIA-2100, manufactured by Sysmex Corp. After that, the solution temperature was cooled down to 30° C., followed by adjustment of pH of the solution to 4.0 by adding hydrochloric acid, and then, the stirring was stopped.

The particles thus prepared were separated from the solution using a basket-type centrifuge “MARK III: model number 60×40” (manufactured by Matsumoto Machine Co., Ltd.) to form a wet cake of toner particles. The above wet cake was rinsed with ionized water at 45° C. using the above-described basket-type centrifuge until an electric conductivity of the filtrate reached 5 μS/cm. After that the rinsed wet cake was transferred to “FLUSH JET DRYER” (manufactured by Seishin Enterprise Co., Ltd.), followed by drying until the moisture content reached 0.5% by mass to prepare toner particles (1).

### (5) Addition of External Additives

To the above toner particles (1), added were 1% by mass of hydrophobic silica (a number average primary particle size of 12 nm) and 0.3% by mass of hydrophobic titania (a number average primary particle size of 20 nm), and then, the mixture was blended using a Henschel mixer, to obtain Gray Toner (1) of the present invention.

The image, fanned on the POD gloss coated paper (produced by Oji Paper Co., Ltd.) having an amount of toner attached of 4 g/m² using the obtained Gray Toner (1) exhibited brightness L* of 37 and chroma C* of 2.8 as defined by L*a*b* color system. The brightness L* and chroma C* were measured by a method described above.

### Production Examples 2 to 9 of Gray Toner

Gray toners (2) to (9) were obtained in a similar manner to the production process of toner particles of the present invention of toner production example 1 of the present invention except that the kinds and the additive amount of the coloring agent dispersion to be added were changed according to a prescription shown in Table 2. In Table 2, gray toners (2) to (6) are examples of the present invention, and gray toners (7) to (10) are comparative examples.

The brightness L* and chroma C* of each gray toners (2) to (9) are shown in Table 2. The brightness L* and chroma C* were measured by a method described above (Production Examples 1 to 9 of Developer)

The ferrite carrier covered with a silicone resin having the volume based median size of 60 μm was mixed with each of the above gray toners (1) to (9) using a V-type mixer to a concentration of 6% by mass with respect to each of the toners, to produce gray developers (1) to (9), which function as a developer used for the gray toner.

### Examples 1 to 6,

### Comparative Examples 1 to 3

The digital system multi functional printer “bizhub PRO C6500” (manufactured by Konica Minolta Business Technologies Co., Ltd.) was converted such that an image forming unit of gray toner was arranged. Into the converted printer, charged were each of gray developers (1) to (9) thus obtained, and each of commercially available developers, a black developer, a yellow developer, a magenta developer, and a cyan developer used for the bizhub PRO C6500 of the aforesaid multi functional printer, and further, as a toner, each of commercially available toners, a black toner, a yellow toner, a magenta toner, and a cyan toner used for the bizhub PRO C6500. Using the above printer, the following evaluations (1) to (5) were carried out. The results are shown in Table 2.

### (1) Uneven Transfer

Two hundred thousand sheets of test image formed by gray toner only were printed out, and generation of uneven transfer was observed visually for the 200,000th print sheet. The evaluation was conducted by the following criteria.

### Evaluation Criteria:

A: No uneven transfer is observed.
B: Though uneven transfer is observed, there is no problem practically.
C: Uneven transfer is observed markedly, and it is practically problematic.

### (2) Color Tinge of Gray Tone

The test chart No. 7 (2008) of the Imaging Society of Japan was printed, which was then evaluated by 50 observers under the same environment (being the same lighting condition and distance) focusing, in particular, on the background of a portrait and a portion of the chart having black gradation. The print was ranked using criteria described below based on the number of observers who evaluated color tinge of a portion of black tone image as being within an achromatic color, that is, the above portion has not, for example, a brown tinge or a red tinge.

### Evaluation Criteria:

A: 45 or more

B: from 5 to 44

C: 4 or less

### (3) Quality of Gray Tone

Hale tone image having image density of 0.4 was printed, and quality of half tone was evaluated by 20 observers visually. Evaluation was conducted by a number of the observers who evaluates the image to have good quality with the following criteria.

### Evaluation Criteria:

A: 15 or more

B: from 10 to 14

C: 9 or less

(4) Color Reproduction of Soft Tone Image

An image consisting of 8 soft tone patches having color codes: #cc6666, #cc9966, #cccc66, #99cc66, #66 cc66, #66cc99, #66 cccc and #6699 cc, was outputted in a printer mode as a soft tone image. The image, together with a color code comparative sample having each soft tone displayed on a display, was evaluated by 50 observers, who were randomly selected from office workers in Tokyo metropolitan, under the same environment (being the same lighting condition and distance). The color reproduction on the print was evaluated in terms of how much each of the observers noticed a red tinge on the print compared to a comparative sample, and most evaluations using criteria described below were used as the evaluation result.

The display condition was

Computer: iMac manufactured by Apple Computer
Display and Mode: 24 inches Wide Screen LCD, Definition of 1,920×1,200 pixel

### Evaluation Criteria:

A: Observer notices no red tinge to the image, even if comparing it to a comparative sample.

B: Observer notices a slight red tinge to the image, but barely notices it without comparing it with a comparative sample.

C: Observer notices a red slight tinge to the image compared to a comparative sample.

D: Observer clearly notices a red tinge to the image without comparing it with a comparative sample.

### (5) Color Reproduction of Dull Tone Image

An image consisting of 6 dark tone patches having color codes: #996666, #999966, #669966, #669999, #666699 and #3996699, was outputted in a printer mode as a dull tone image. The image, together with a color code comparative sample having each dark grayish tone displayed on a display as described above, was evaluated by 50 observers under the same environment (being the same lighting condition and distance). The color reproduction on print was evaluated in terms of how much each of the observers noticed a red tinge on the print compared to a comparative sample, and most evaluations using criteria described below were used as the evaluation result.

### Evaluation Criteria

A: Observer notices no red tinge to the image, even if comparing it to a comparative sample.

B: Observer notices a slight red tinge to the image, but barely notices it without comparing it with a comparative sample.

C: Observer notices a red slight tinge to the image compared to a comparative sample.

D: Observer clearly notices a red tinge to the image without comparing it with a comparative sample.

TABLE 2

| | | | | Content based on 100 parts | | | | | | | | | |
|---|---|---|---|---|---|---|---|---|---|---|---|---|---|
| | | | | by mass of binding resin | | | | | Result of Evaluation | | | | |
| | | Coloring agent | | (parts by mass) | | | | | | Color | | S | D |
| | | dispersion | | First | Second | | Bright- | | | Tinge | Quality | Color | Color |
| | Toner | | Amount | Coloring | Coloring | | ness | Chroma | Uneven | of Gray | of Gray | Reproduction | Reproduction |
| | No. | No. | (g) | Agent | Agent | Sum | L* | C* | Transfer | Tone | Tone | (*1) | (*2) |
| Example 1 | 1 | 1 | 82 | 0.90 | 0.87 | 1.77 | 37 | 2.8 | A | A | A | A | A |
| Example 2 | 2 | 2 | 80 | 0.79 | 0.82 | 1.61 | 48 | 2.6 | B | A | A | A | B |
| Example 3 | 3 | 3 | 87 | 0.77 | 0.82 | 1.59 | 34 | 2.1 | A | A | B | A | A |
| Example 4 | 4 | 4 | 91 | 0.80 | 0.75 | 1.55 | 41 | 2.3 | B | A | A | A | A |
| Example 5 | 5 | 5 | 88 | 1.01 | 1.23 | 2.24 | 32 | 1.9 | A | A | A | A | A |
| Example 6 | 6 | 6 | 90 | 0.87 | 0.91 | 1.78 | 36 | 2.7 | A | A | B | A | A |
| Comparative | 7 | 7 | 189 | 5.90 | 0.00 | 5.90 | 21 | 6.9 | C | B | C | C | C |
| Example 1 | | | | | | | | | | | | | |
| Comparative | 8 | 8 | 85 | 0.35 | 0.00 | 0.35 | 58 | 13.2 | C | B | C | B | C |
| Example 2 | | | | | | | | | | | | | |
| Comparative | 9 | 9 | 85 | 1.90 | 2.00 | 3.90 | 26 | 12.1 | B | B | C | B | C |
| Example 3 | | | | | | | | | | | | | |

(*1): S Color Reproduction: Color reproduction of soft tone image,
(*2): D Color Reproduction: Color reproduction of dull tone image

1. An electrostatic image developing gray toner composed of toner particles comprising a binding resin, two species of chromatic color coloring agents and carbon black in an amount of 0 to 0.001 weight % of amount of the chromatic color coloring agents, wherein
brightness L* is 30 to 90 and chroma C* is not more than 10 in L*a*b* color system measured in single solid toner image formed by only the gray toner having an amount of toner attached of 4 g/m², and
the two species of chromatic color coloring agents satisfy mutually complementary color relation.

2. The electrostatic image developing gray toner of claim 1, wherein a sum of content of the two species of chromatic color coloring agent is 0.5 to 3 mass parts based on 100 mass parts of the binding resin.

3. The electrostatic image developing gray toner of claim 2, wherein a sum of content of the two species of chromatic color coloring agent is 1.0 to 2.5 mass parts based on 100 mass parts of the binding resin.

4. The electrostatic image developing gray toner of claim 1, wherein the two species of chromatic color coloring agents are composed of a yellow coloring agent and a blue coloring agent.

5. The electrostatic image developing gray toner of claim 1, wherein the two species of chromatic color coloring agents are composed of a magenta coloring agent and a green coloring agent.

6. The electrostatic image developing gray toner of claim 1, wherein the two species of chromatic color coloring agents are composed of a cyan coloring agent and a red coloring agent.

7. The electrostatic image developing gray toner of claim 1, wherein brightness L* is 30 to 50 in L*a*b* color system measured in single solid toner image formed by only the gray toner having an amount of toner attached of 4 g/m².

8. The electrostatic image developing gray toner of claim 1, wherein chroma C* is 1.5 to 3.0 in L*a*b* color system measured in single solid toner image formed by only the gray toner having an amount of toner attached of 4 g/m².

9. The electrostatic image developing gray toner of claim 1, wherein the toner particles comprise a charge control agent.

10. An electrostatic image developing gray toner composed of toner particles comprising a binding resin, two species of chromatic color coloring agents and carbon black in an amount of 0 to 0.001 weight % of amount of the chromatic color coloring agents, wherein the two species of chromatic color coloring agents have complementary colors, and a sum of content of the two species of chromatic color coloring agent is 0.5 to 3 mass parts based on 100 mass parts of the binding resin.

11. The electrostatic image developing gray toner of claim 10, wherein a sum of content of the two species of chromatic color coloring agent is 1.0 to 2.5 mass parts based on 100 mass parts of the binding resin.

12. The electrostatic image developing gray toner of claim 10, wherein the two species of chromatic color coloring agents are composed of a yellow coloring agent and a blue coloring agent.

13. The electrostatic image developing gray toner of claim 10, wherein the two species of chromatic color coloring agents are composed of a magenta coloring agent and a green coloring agent.

14. The electrostatic image developing gray toner of claim 10, wherein the two species of chromatic color coloring agents are composed of a cyan coloring agent and a red coloring agent.

15. An image forming method using plural numbers of electrostatic image developing toners having different color, wherein the electrostatic image developing gray toner of claim 1 is used.

16. The image forming method of claim 15 wherein the plural numbers of electrostatic image developing toners include yellow, magenta, cyan and black toner.
